(19) United States
(12) Patent Application Publication
(10) Pub. No.: US 2003/0136803 A1
(43) Pub. Date: Jul. 24, 2003

(54) Inner plug of a container for holding beverage

(76) Inventors: Toshiaki Kuwano, Tokyo (JP); Kunio Hatsumoto, Tokyo (JP); Yasuhiro Kowa, Tokyo (JP)

Correspondence Address: J.C. Patents, Inc., Suite 250, 4 Venture, Irvine, CA, 92618, US

(21) Appl. No.: 10/346,244

(22) Filed: Jan. 14, 2003

(30) Foreign Application Priority Data
Jan. 18, 2002 (JP) 2002-10120
Jan. 18, 2002 (JP) 2002-10121

(51) Int. Cl. B67D 3/00

(52) U.S. Cl. 222/481.5

(57) ABSTRACT

A nozzle unit is attached onto the lower side of a bottom plate of a plug body. A fin and a pair of side plates protrude from the nozzle unit. The fin is arranged below and apart from the liquid-passage hole in the bottom plate in horizontal direction. The side plates are arranged in vertical direction, and put the liquid-passage hole and the fin between them. When a hot drink is poured into the container body to increase the inner pressure of the container body, the fin and the side plates can obstruct the exhausting flow rate of the inner pressure so that the inner pressure cannot be exhausted rapidly. When the fin is bent towards the liquid-passage hole due to the increased inner pressure, the inner pressure can be exhausted efficiently according to its magnitude.

### CROSS-REFERENCE TO RELATED APPLICATION

This application claims the priority benefit of Japan application serial no. 2002-10120, filed on Jan. 18, 2002 and 2002-10121, filed on Jan. 18, 2002.

### BACKGROUND OF THE INVENTION

1. Field of the Invention

This invention relates in general to inner plugs of various containers for holding a beverage such as a vacuum bottle, a canteen and a sports drink container.

2. Description of Related Art

The conventional inner plug for a portable vacuum bottle is as shown in FIG. 5. The conventional inner plug 101 comprises a plug body 104 encapsulating the upper opening of the container body 103 of the vacuum bottle 102 and a lid body 106 capable of opening or closing to cover the lip portion 105 of the plug body 104, wherein a liquid-passage hole 107 and an air hole 108 are opened in the bottom plate of the plug body 104 that is under the lower side of the lip portion 105. Because air can be supplied inside the container body 103 through the air hole 108 following with the decrement of the beverage content, the drink D can be poured out efficiently.

However, the liquid-passage hole 107 is just an opening disposed near the air hole 108. There is not much difference between the distance from the liquid surface D1 to the liquid-passage hole 107 and that from the liquid surface D1 to the air hole 108. They are both exposed to the same hydraulic pressure. When the drink D is poured out through the liquid-passage hole 107, pulses will be created interfering with the smooth pouring out of the drink D and the drink D may spill to the surroundings. Therefore, conventional technique has tried to suspend a straight tube nozzle 109 under the air hole 108 to arrange the liquid-passage hole 107 apart from the lower opening 109a of the nozzle 109 so as to make the difference between the distance L1 from the liquid surface D1 to the liquid-passage hole 107 and the distance L2 from the liquid surface D1 to the lower opening 109a become larger. When a user drinks, the difference of the hydraulic pressure between the liquid-passage hole 107 and the lower opening 109a is large enough to obstruct the pulses.

With such a structure, when a user puts a hot drink into the container body and closes the container body, the temperature of the air sealed above the beverage will rise to increase the inner pressure of the container body. When a user tries to open the container body under this condition, the inner pressure exhausts the steam and the high-temperature air to spread out through the liquid-passage hole in a second and the beverage contained inside the container body also spreads out so that the pouring of the liquid is interfered with and so it may spill to the surroundings.

With such a structure, the nozzle 109 is a straight tube arranged along the central line O1 of the air hole 108, and when the container body 103 inclines such that the liquid-passage hole 107 inclines downwardly to pour out the drink D as shown in FIG. 5, because of the lower opening 109a of the nozzle 109 being substantially apart from the liquid surface D1 with a distance L2, the hydraulic pressure will act on the lower opening 109a of the nozzle 109 so as to interfere with the air supply into the container body 103 through the nozzle 109 obstructing the smooth pouring out of the beverage

If the nozzle 109 is set to be longer, the hydraulic pressure acting on the lower opening 109a will become smaller. Under this condition, because the nozzle 109 protrudes from the plug body 104 with a long length, it is difficult to form the plug body 104, and it is detrimental to the stability of the plug body 104 when the plug body 104 is taken out of the container body 103, and it will also make the lower opening 109a come into contact with the table which is not hygienic.

### SUMMARY OF THE INVENTION

This invention is developed based on the above situations. An objective of this invention is to provide an inner plug of a container for holding beverage, which can obstruct the pulses when the beverage is poured out and can obstruct the hydraulic pressure from interfering with the flowing of the supplement air so that the beverage can be poured out smoothly.

It is another object of the present invention to provide an inner plug of a container for holding beverage where even if a hot drink is stored, the exhausting inner pressure with the beverage can be prevented from spreading rapidly and the beverage can be poured out without being interfered with.

According to an aspect of the invention, there is provided an inner plug of a container for holding beverage, comprising: a plug body, encapsulating an upper opening of a container body; and a lid body, liquid-sealing a liquid-passage hole opened in a bottom plate of the plug body. A fin is arranged under and apart from the liquid-passage hole to obstruct an inner pressure exhausting from the container body.

The fin can be bent towards the liquid-passage hole due to the increased inner pressure to obstruct an exhausting flow rate of the inner pressure according to a magnitude of the inner pressure. A pair of side plates are suspended under the bottom plate to put the fin between them to achieve an effect of obstructing the exhausting flow rate of the inner pressure.

According to another aspect of the invention, there is also provided an inner plug of a container for holding beverage, comprising: a plug body, encapsulating an upper opening of a container body; and a lid body, covering a liquid-passage hole and an air hole, which is opened in a bottom plate of the plug body, in a manner capable of being opened and closed. A nozzle is suspended under the air hole, and a lower opening of the nozzle is disposed in the opposite side of the liquid-passage hole on the basis of the position of the air hole. The lower opening of the nozzle also can be disposed more above a lower portion of the plug body. The nozzle is detachable.

### BRIEF DESCRIPTION OF THE DRAWINGS

While the specification concludes with claims particularly pointing out and distinctly claiming the subject matter which is regarded as the invention, the objects and features of the invention and further objects, features and advantages thereof will be better understood from the following description taken in connection with the accompanying drawings in which:

FIG. 1 is a cross-sectional enlargement view showing the upper portion of the vacuum bottle with the lid body thereof is opened according to one embodiment of the present invention;

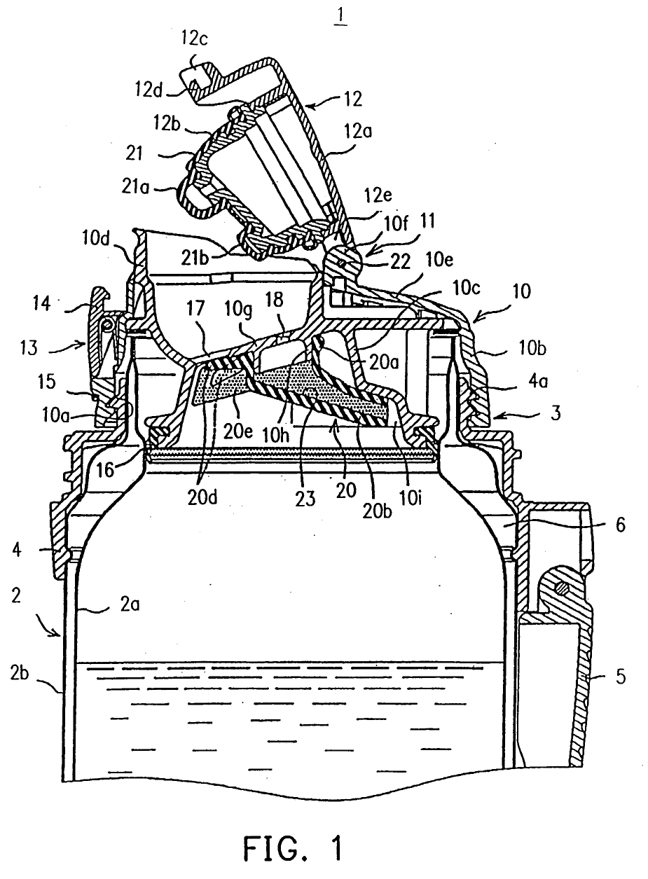

FIG. 2 is a cross-sectional enlargement view showing the upper portion of the vacuum bottle of FIG. 1 in a closed state;

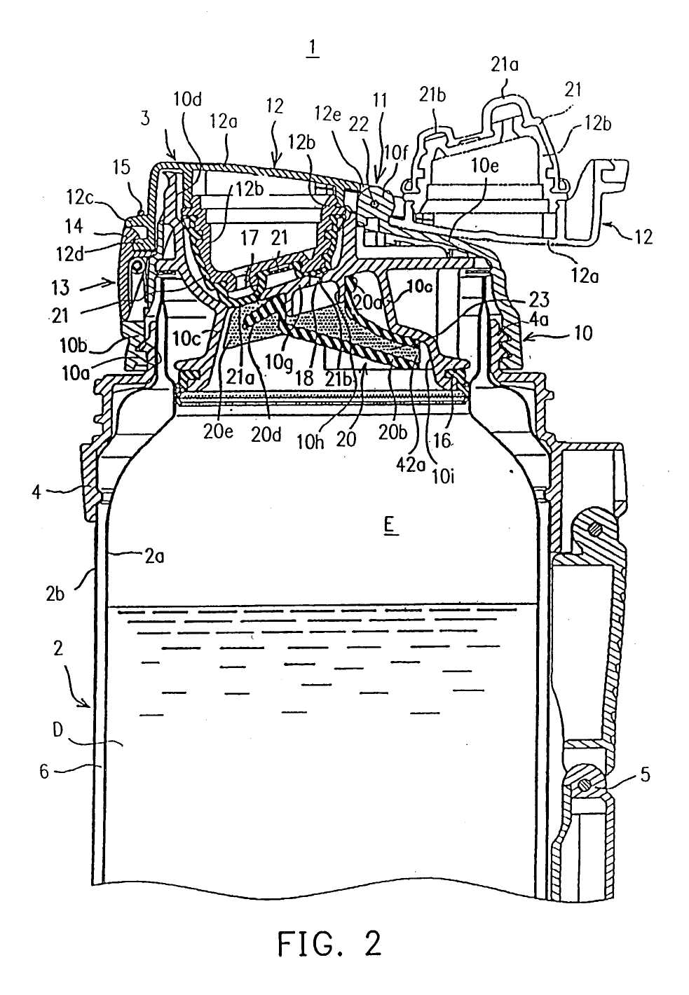

FIG. 3 is a bottom view showing the inner plug according to one embodiment of the present invention;

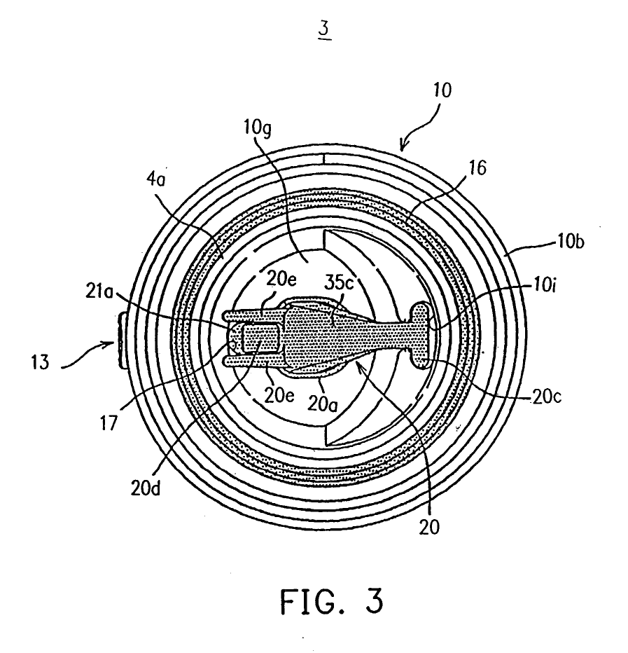

FIG. 4 is an enlargement view showing the upper portion of the vacuum bottle with the lid body of FIG. 1 opened to pour out the beverage; and

FIG. 5 is a cross-sectional view showing the upper portion of the conventional vacuum bottle.

### DESCRIPTION OF THE PREFERRED EMBODIMENT

One embodiment of the present invention which is suitable for a vacuum bottle will be explained with reference to the drawings.

The vacuum bottle 1 comprises a container body 2 made of a metal, an inner plug 3 made of a synthetic resin encapsulating the upper opening of the container body 2 and a loop body 4 fixed onto the upper portion of the container body 2, wherein a stretchable handle 5 is arranged at one side of the container body 2.

The container body 2 is a dual heat insulation structure, wherein an inner container 2a and an outer container 2b are formed in one at the upper edges of the openings and a space between the inner container 2a and the outer container 2b is made to be a vacuum heat insulation layer 6, and the loop body 4 is fit on the upper portion of the outer circumference of the outer container 2b. An external thread 4a is formed on the upper portion of the outer circumference of the loop body 4 for engaging with the inner plug 3. The inner plug 3 comprises a plug body 10 attached in the upper opening of the container body 2, a lid body 12 capable of opening or closing to be connected to the plug body 10 by using a hinge 11, and a lock means 13 arranged opposite to the hinge 11 to keep the lid body 12 in a fully closed state.

The plug body 10 comprises: an outer cylinder 10b whose inner thread 10a is screwed to the external thread 4a of the loop body 4 for installing the outer cylinder 10b onto the outer container 2b, an inner cylinder 10c for being inserted to the inner container 2a, a hopper-shaped lip portion 10d with a small diameter extending to one side of these cylinders 10b, 10c, and a ceiling plate 10e extending to the upper portion of the outer cylinder 10b to surround the lip portion 10d.

A seesaw-type lock button 14 and an engaging loop 15 constructing the lock means 13 are arranged at one side of the outer cylinder 10b. The guide rib 10f constructing the hinge 11 is arranged in a manner that adjoins the lip portion 10d on the ceiling plate 10e. A loop gasket 16 is arranged at the lower portion of the outer circumference of the inner cylinder 10c. The container body 2 is liquid-sealed by using the loop gasket 16. Between the lip portion 10d and the inner cylinder 10c, the bottom plate 10g is arranged in a manner such that it inclines downwardly at the lock means side. A liquid-passage hole 17 and an air hole 18 are opened in the bottom plate 10g and a nozzle unit 20 is continuously arranged under the bottom plate 10g.

Within the lid body 12, a boss portion 12b protrudes from the lower side of the ceiling plate 12a, and a gasket 21 is attached onto the boss portion 12b, and sealing portions 21a, 21b protrude from the lower surface of the gasket 21. An engaging rib 12c and an engaging plate 12d protrude from one side of the ceiling plate 12a and a pair of arms 12e is arranged at the other side of the ceiling plate 12a.

The hinge 11 is constructed in a manner using the pair of arms 12e of the lid body 12 to put the guide rib 10f of the plug body 10 between them and to thread a hinge shaft 22 through the pair of arms 12e. When the lid body 12 is rotated to a closed state, the boss portion 12b attached with the gasket 21 is received in the lip portion 10d and the sealing portions 21a, 21b liquid-seal the liquid-passage hole 17 and the air hole 18 respectively.

The lock means 13 comprises the lock button 14 of the plug body 10, the engaging loop 15, the engaging rib 12c and the engaging plate 12d. The lock button 14 is latched to the engaging plate 12d of the lid body 12 when the lid body 12 is rotated to a closed position. The engaging loop 15 is hung on the engaging rib 12c with a reverse U shape to keep the lid body 12 in a fully closed state. When a user needs to open the lid body 12 in a fully closed state, the user detaches the engaging loop 15 hung on the engaging rib 12c and pushes the lower side of the lock button 14 to release the connection of the lock button 14 and the engaging plate 12d. As a result, a rebound of a torsion spring (not shown) reeled in the hinge shaft 22 is used to energize the lid body 12 in an open direction.

The nozzle unit 20 is one unit combined by a nozzle 20b extending to the lower side of the air hole 18, a fin 20d and side plates 20e, 20e attached onto the nozzle 20b. They are made of a soft synthetic resin such as silicon or a plasticity material such as rubber. The nozzle 20b is a bending tube whose one end is formed into a loop installation portion 20a, and a nozzle portion 35c under the loop installation portion 20a taperingly inclining sideward is formed into a continuous bending tube. The engaging plate 20c is continuously arranged perpendicular to the axis of the nozzle portion 35c at the lower end of the nozzle portion 35c.

Under the bottom plate 10g of the plug body 10, the rib 10h is set surrounding the air hole 18, and an engaging recession 10i is set at the lower portion of the inner wall of the inner cylinder 10c at the hinge side. The nozzle unit 20, wherein the loop installation portion 20a embeds in the rib 10h, and the nozzle portion 35c inclines opposing the liquid-passage hole 17 so that the engaging plate 20c engages with the engaging recession 10i. As a result, the nozzle unit 20 can be detachably installed in the plug body 10. Because of the engaging plate 20c of the lower end of the nozzle 20b engaging with the engaging recession 10i in the inner cylinder 10c, the whole body of the nozzle unit 20 is received inside the plug body 10.

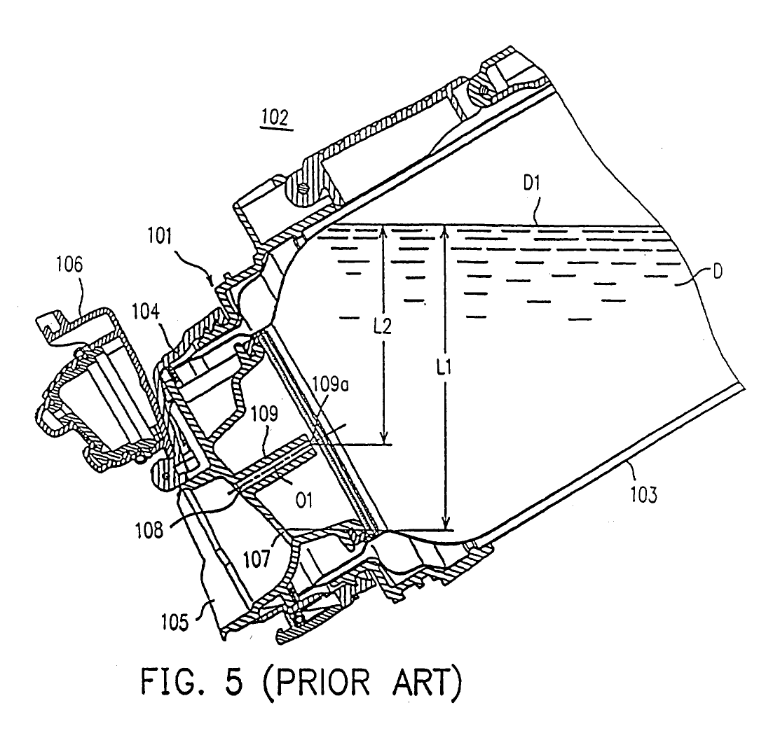

A hollow passage 23 is formed in the nozzle 20b, wherein the upper end of the passage 23 communicates outside through the air hole 18 and the lip portion 10d, and a lower opening 42a of the passage 23 is disposed from the center of the air hole 18 to a position opposite to the liquid-passage hole 17. The lower opening 42a is disposed closer to the liquid surface D1 with a distance L3 than the conventional one with a distance L2 (see FIG. 5). Under this condition, the lower opening 42a communicates with the upper portion of the container body 2, and outside air is supplied through the passage 23 following with the decrement of the beverage. Therefore, the beverage D can smoothly flow passing the liquid-passage hole 17.

The plate-shaped fin 20d and a pair of side plates 20e, 20e that is oppositely disposed at two sides of the fin 20d integrally protrude on the loop installation portion 20a of the nozzle unit 20. When the nozzle unit 20 is arranged under the bottom plate 10g, the fin 20d is arranged under and apart from the liquid-passage hole 17 in horizontal direction, and the side plates 20e, 20e are arranged in vertical direction, and put the liquid-passage hole 17 and the fin 20d between them.

When the beverage D in the container body 2 is at a high-temperature, the temperature of the air layer E in the upper portion of the container body 2 rises. The objective of setting the fin 20d and the side plates 20e, 20e is to obstruct the inner pressure to exhaust the high-temperature steam or air to spread rapidly through the liquid-passage hole 17 when opening the inner plug 3. The fin 20d encounters the increased inner pressure exhausting below to bend towards the liquid-passage hole 17 and then obstructs the exhausting flow rate. The side plates 20e, 20e obstruct the exhausting flow rate of the inner pressure entering the liquid-passage hole 17 through the sides of the liquid-passage hole 17.

The fin 20d is formed to be thinner than the side plates 20e, 20e such that the fin 20d can be bent towards the liquid-passage hole 17 according to the magnitude of the inner pressure. In the case when the fin 20d is bent most, though it is fast attached on the lower surface of the bottom plate 10g of the plug body 10 to block most of the liquid-passage hole 17, it still leave a small gap for the liquid-passage hole 17 at its lock means side. Therefore, the inner pressure can be exhausted, while the exhausting flow rate thereof is obstructed to be minimum.

Though the side plates 20e, 20e are arranged for the same objective as the fin 20d, the side plates 20e, 20e are perpendicular to the liquid-passage hole 17. Even though the side plates 20e, 20e are expected not to move, if they are bent towards the liquid-passage hole 17, in order for this not to cause much adjustment effect to the exhausting flow rate of the inner pressure, the thickness of the side plates 20e, 20e is preferably set such that the side plates 20e, 20e will not interfere with the fin 20d and they are fast attached onto the bottom plate 10g. However, the side plates 20e, 20e are still allowed to be bent in a range without interfering with the fin 20d.

With the structure of the present embodiment, a bending tube with the loop installation portion 20a and the nozzle portion 35c continuously inclining thereto is used in the nozzle 20b extending to the lower side of the air hole 18. By arranging the nozzle portion 35c to incline opposing the liquid-passage hole 17, when pouring out the beverage D contained inside the container body 2, the lower opening 42a of the passage 23 is always disposed above the liquid-passage hole 17. Therefore, the outside air can be smoothly supplied into the container body 2 through the lower opening 42a of the passage 23 of the nozzle 20b, and then pulses of the beverage D can be extremely obstructed, so that the beverage D can be drawn smoothly and will not spread to and pollute the surroundings of the vacuum bottle 1.

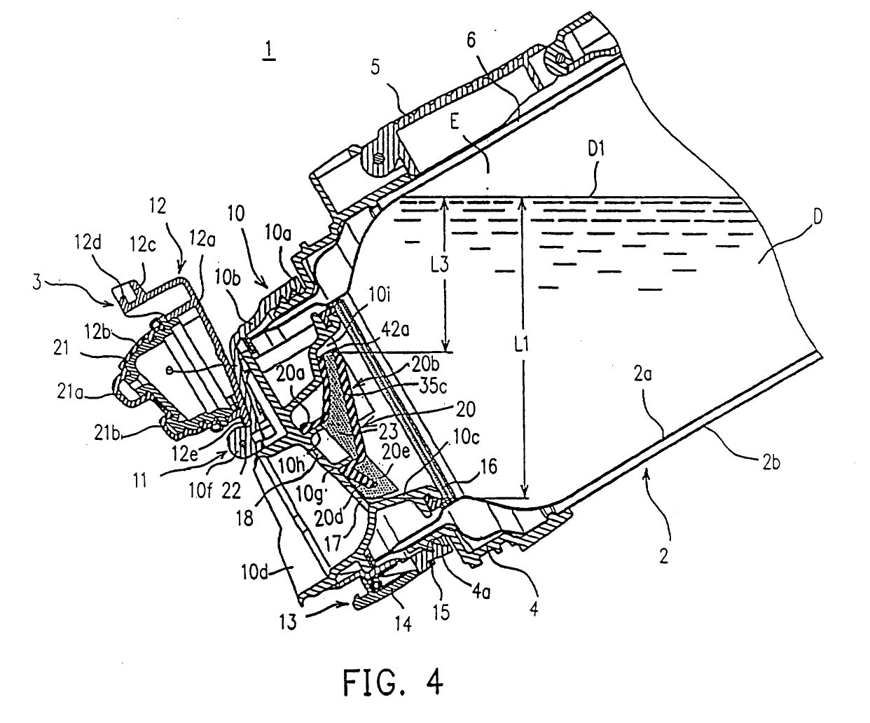

Moreover, when the container body 2 is downwardly inclined to pour the beverage D contained inside the container body 2 as shown in FIG. 4, the lower opening 42a of the passage 23 of the nozzle 20b is disposed facing up, and the distance L3 from the liquid surface D1 to the lower opening 42a is surely shorter than the distance L1 from the liquid surface D1 to the liquid-passage hole 17 and also shorter than the distance L2 of the conventional one. Therefore, the lower opening 42a encounters a lesser hydraulic pressure than the conventional one, and the outside air can be supplied smoothly through the passage 23, and then the beverage D can be poured out much more smoothly.

Additionally, the lower opening 42a of the passage 23 of the nozzle 20b is disposed above the loop gasket 16 attached at the lower end of the plug body 10, such that the whole body of the nozzle unit 20 can be received in the plug body 10. Therefore, when the plug body 10 is taken out from the container body 2 to be placed on a plane, there is no unnecessary protrusion on the plug body 10, so that the plug body 10 can have a good stability, and the lower opening 42a is not directly in contact with the plane where the plug body 10 is placed, and so it is very hygienic.

Furthermore, because the nozzle unit 20 and the plug 10 are formed individually and the nozzle unit 20 is detachably installed in the plug body 10, the formation performance thereof can be improved and the cost thereof can be decreased, and they also can be washed up easily.

With the structure of the present embodiment, in the case when a user pours hot drinks into the container body 2 of the container 1 and closes the lid body 12, though the temperature of the air sealed above the beverage inside the container body 2 rises to increase the inner pressure, if the user opens the lid body 12 under this condition, the exhausting flow rate of the increased inner pressure exhausted as high-temperature steam and air through the liquid-passage hole 17 will be obstructed by the fin 20d and the side plates 20e, 20e. Therefore, the inner pressure can be obstructed to exhaust rapidly. Because of the fin 20d under the liquid-passage hole 17 being made of a plasticity material and can be bent towards the liquid-passage hole 17, the inner pressure can be exhausted efficiently according to the magnitude of the inner pressure.

As a result, when the inner pressure of the container body 2 has been exhausted, the fin 20d returns to its original position under the liquid-passage hole 17 and then an original gap is left between the liquid-passage hole 17 and the fin 20d, therefore, the beverage can be poured out through the gap. In this way, the beverage will not spread out and pollute the surroundings due to the exhausted inner pressure or the beverage, and the beverage can be poured out smoothly without interference.

In the case when the container body 2 is inclined to pour out the beverage, though some turbulence will be created nearby the liquid-passage hole 17 to interfere with the pouring of the beverage, the fin 20d and the side plates 20e, 20e can be expected to have the function of being a rectifying plate to obstruct the turbulences and are helpful to allow for the efficient pouring out of the beverage.

Furthermore, because the fin 20d and the side plates 20e, 20e are made of a plasticity material such as soft synthetic resin and rubber, they are easily formed and the nozzle unit 20 will not tend to rust even if it gets wet during washing of the inner plug 3, therefore it is very hygienic. Also because the fin 20d is separately below the liquid-passage hole 17, even if ice is put in the container body 2, the ice will not block the liquid-passage hole 17 and the cold water can be poured out.

Although the container body is inclined downwardly in the above descriptions, the same effect can be achieved by inclining the container body towards a level direction or upward.

In the above embodiment, though it has being described that the fin and the side plates are attached onto the nozzle of the nozzle unit, the present invention can also be practiced by using only the nozzle body. Moreover, the lower opening of the nozzle of the present invention can be positioned in the opposite side of the liquid-passage hole on the basis of the position of the air hole, and the nozzle can be formed into a bending tube or an inclining tube out of the example in the embodiment or can be formed by combining these shapes. The lower end of the nozzle can be latched to a part out of the engaging recession portion in the embodiment or unlatched.

With the structure of the above embodiment, though the fin and the side plates arranged under the bottom plate are made of a plasticity material, these elements can also be formed by resilient material such as spring plates or rigid material. When the fin and the side plates are formed by using a rigid material, they can be integrally formed on the bottom plate of the plug body or can be individually structured to assemble onto the plug body. Moreover, in the case when the plug body has an air hole, the fin and the side plates of the present invention can also have an air hole.

As in the above description, in the inner plug of a container for holding beverage of the present invention, even if a hot drink is poured into the container body such that the inner pressure of the container body increases, the fin and the side plates can obstruct the exhausting flow rate of the inner pressure to exhaust rapidly. Therefore, the surroundings of the container will not be polluted due to the exhausted inner pressure or the beverage, and the beverage can be poured out without interference. By using the increased inner pressure to bend the fin towards the liquid-passage hole, the inner pressure can be exhausted efficiently according to its magnitude.

Moreover, the fin and the side plates are helpful to obstruct the turbulence created nearby the liquid-passage hole as a rectifying plate, and the beverage can be poured out efficiently.

As in the above description, the inner plug of a container for holding beverage of the present invention can extremely obstruct pulses during pouring out of the beverage and obstruct the hydraulic pressure from interfering with the entering of the supplement air, so that the beverage contained inside the container can be poured out smoothly. Moreover, because the lower opening of the nozzle is disposed above the lower end of plug body, when the plug body is taken out from the container body to be placed in a plane, there is no unnecessary protrusion on the plug body and the stability of the plug body is good. The lower opening of the nozzle is not directly in contact with the plane where the plug body is placed, therefore, it is very hygienic. Furthermore, the nozzle is detachably installed onto the plug body such that the formation performance thereof can be improved, and the cost thereof can be decreased, and they can be washed up easily.

While the present invention has been described with a preferred embodiment, this description is not intended to limit our invention. Various modifications of the embodiment will be apparent to those skilled in the art. It is therefore contemplated that the appended claims will cover any such modifications or embodiments as fall within the true scope of the invention.

What is claimed is:

1. An inner plug of a container for holding beverage, comprising:
a plug body, encapsulating an upper opening of a container body; and
a lid body, liquid-sealing a liquid-passage hole opened in a bottom plate of the plug body,
wherein a fin is arranged under and apart from the liquid-passage hole to obstruct an inner pressure exhausting from the container body.

2. The inner plug of claim 1, wherein the fin is bent towards the liquid-passage hole due to an increased inner pressure to obstruct an exhausting flow rate of the inner pressure according to a magnitude of the inner pressure.

3. The inner plug of claim 1, wherein a pair of side plates are suspended under the bottom plate to put the fin between them.

4. An inner plug of a container for holding beverage, comprising:
a plug body, encapsulating an upper opening of a container body; and
a lid body, covering a liquid-passage hole and an air hole, which are opened in a bottom plate of the plug body, in a manner capable of being opened and closed,
wherein a nozzle is suspended under the air hole, and a lower opening of the nozzle is disposed in an opposite side of the liquid-passage hole on a basis of a position of the air hole.

5. The inner plug of claim 4, wherein the lower opening of the nozzle is disposed above a lower portion of the plug body.

6. The inner plug of claim 4, wherein the nozzle is detachable.
